(19) United States
(12) Patent Application Publication
(10) Pub. No.: US 2017/0286437 A1
(43) Pub. Date: Oct. 5, 2017

(54) METHODS AND SYSTEMS FOR ARCHIVING COMPUTER FILES

(71) Applicant: yours.co, American Fork, UT (US)

(72) Inventors: Matthew Stevens, Lehi, UT (US); Spencer Lambert, Woodland Hills, UT (US); John David Galbraith, South Jordan, UT (US); Justin Whittaker, Provo, UT (US)

(21) Appl. No.: 15/475,113

(22) Filed: Mar. 30, 2017

Related U.S. Application Data
(60) Provisional application No. 62/315,554, filed on Mar. 30, 2016.

(51) Int. Cl. G06F 17/30

(52) U.S. Cl. CPC G06F 17/30073; G06F 17/30076; G06F 17/30097

(57) ABSTRACT

A system for archiving data owned by a requester, or an archiver, includes components that enable an archiver to access the requester's data from a third party data storage service (i.e., the Cloud), write the data to a physical archival medium and delivering the physical archival medium on which the data has been archived to the requester. Methods for archiving data are also disclosed.

### TECHNICAL FIELD

This disclosure relates to methods for archiving data owned by a requester and, more specifically, to methods for enabling an archiver to access the requester's data from a third party, write the data to an archival medium and deliver the archival medium on which the data has been archived to the requester.

### DISCLOSURE

In various embodiments, systems and methods for archiving data are disclosed.

A system for archiving data may include a download server, a data staging area and an asynchronous recording unit (ARU). Such a system operates under control of a party that is referred to herein as an “archiver.” When used in a method according to this disclosure, the download server may receive a request from a party who wants to archive its, his or her data. Such a party is referred to herein as a “requester” or as a “customer.” Once the download server receives a request, the download server may obtain the requester's data from a third party. That data may be transmitted, or sent, to the data staging area, which includes memory where the data may be temporarily stored until the ARU is able to copy the data onto an archival medium. The data on the archival medium may be compared with the data temporarily stored by the data staging area to confirm that only the requester's data is stored, or archived, by the archival medium. The system may also include a transmittal component and/or a secure storage component. A transmittal component may receive the archival medium or media from the ARU and send it to an address designated by the requester. A secure storage component may comprise a secure location where the archival medium may be stored until the user requests it, for example, by way of a request that the archival medium be sent to an address designated by the requester.

In various embodiments of a method according to this disclosure, the requester accesses the archiver (e.g., archiver's web site, etc.) through a user interface (e.g., an internet browser, etc.) to initiate a call to action (e.g., by selecting a particular action, such as an “Archive Now” icon, etc.). When the requester initiates the call to action, the archiver (e.g., through the user interface to the download server, etc.) enables the requester to identify a website or other internet-accessible location from which the archiver may access the data the requester would like to archive, and links to that location. Such a location is commonly referred to as “the Cloud,” and may include data storage administered by any of a variety of providers, including, without limitation, Dropbox, Google Drive, Apple iCloud and Facebook. While the requester accesses that location, the requester may provide the archiver with authorization to access the requester's data at that location. Such authorization may be granted in any suitable manner, including, but not limited to, use of an OAuth authentication protocol, which may enable the archiver to act on the requester's behalf without requiring the requester to provide the archiver with its, his or her password. Once the requester has granted the archiver access to the requester's third party account and, thus, to the requester's data stored in connection with that account, the user interface returns the requester to the archiver's user interface. Optionally, the requester may require that the archived data be encrypted.

Once the archiver has access to the requester's data, the archiver (e.g., by way of the download server, etc.) may access the data stored by the requester in connection with the requester's third party account. More specifically, the archiver may interface with the third party's application program interface (API), which specifies how software components should interact with the third party's system(s), in a manner that complies with the third party's API requirements to access and to analyze and/or retrieve any data that has been stored in connection with the requester's account.

Upon accessing the requester's account, the archiver may index all of the data files that are stored in connection with that account. Indexing may enable the archiver to distinguish between files that will be archived and files that will not be archived. Without limitation, indexing of the data files may enable them to be archived on the basis of whether or not the requester has selected them for archival, whether or not they fall within an archival date range (e.g., date originally obtained, date saved in connection with the requester's account, etc.) and/or whether or not they were previously archived. Indexing files on the basis of whether or not they have been previously archived may enable the archiver to continuously archive the requester's data over a plurality of sessions without re-archiving any data files that have already been archived (i.e., duplicative or redundant archival). Thus, the archiver may (e.g., by way of the download server, etc.) re-access the data associated with the requester's third party account at a later time and, upon indexing the data, identify any new data and/or any data that was not previously archived and download the same for a subsequent archival session. Subsequent access and archival may be conducted pursuant to intermittent requests by a requester or, if the requester desires, on a periodic basis (e.g., daily, weekly, monthly, quarterly, annually, etc.).

After the archiver has identified which of the requester's files, or data, are to be archived, the archiver may (e.g., by way of the download server, etc.) download each file that is to be archived. The download process may be secure.

The downloaded files may then be, in a process known as “spanning,” assembled into groups, or chunks, that can be stored by a type of archival medium that has been specified for the archival process (e.g., a write once optical disc available from Mitsubishi Kagaku Media Co., Ltd., under the VERBATIM and M-DISC trademarks having a storage capacity of 25 GB (BD-R) (Blu-ray disc recordable), 50 GB (BD-R) or 100 GB (BD-XL) (Blu-ray disc, extra large), etc.). In embodiments where more than one archival medium will be required to archive the data, in addition to spanning the data for use across a plurality of different archival media, the archiver may replicate directory structures and conserve file hierarchy across all of the archival media that are to be used in the archiving session.

Once the downloaded data files have been spanned, the data files may be packaged and saved in one or more “ISO images” or “ISO files,” each of which comprises a packaged file that corresponds to a single unit of archival medium (e.g., an optical disc, etc.) and comprises the data contents from every sector that is to be written onto the archival medium, including the file system for the archival medium. If the requester has required that the archived data be encrypted, encryption of the data may occur as each ISO image is generated, or assembled. The name of each ISO image may be a unique identifier that corresponds to the requester and to the unit of archival medium on which the ISO image is to be archived. In addition, the archiver (e.g., by way of the download server, etc.) may generate a file name, or identifier, for the ISO image that corresponds to the requester and the data that is to be archived.

In some embodiments, an MD5 hash, or message digest, may also be generated to provide a “thumbprint” of the data files that have been incorporated into an ISO image. The MD5 hash may be used to verify the integrity of the data in an ISO image after the ISO image has been transferred or copied to a temporary storage medium and/or to an archival medium.

Files for a label for the archival medium and/or a shipping label may also be generated for each unit of archival media on which the requester's data is to be archived. Files for labels, including labels for the archival medium and shipping labels, may be referred to as “print files.” The generation of a print file may include the generation of a printable code (e.g., a QR (quick-response) code, another type of matrix bar code, another type of two-dimensional bar code, a one-dimensional bar code, another optically readable code, etc.) that is unique to the archival session. The information on or otherwise associated with each print file may be subsequently used to confirm that all of the data that has been archived on an archival medium (or a plurality of archival media) belongs to a particular requester and that the archival medium (or media) will be sent to a location specified by that requester. In a particular embodiment, the information on or otherwise associated with the print file may include a unique identifier for archiving session. Without limitation, each print file may include information that corresponds to the requester's identity; the date the requester's data was accessed, indexed, downloaded and/or processed; or the like. Each print file may also include information about the number of archival media by which the data is to be archived, as well as a number for each archival medium when a plurality of archival media is required for the archiving session. The information included in the print file may correspond to information contained in the name for a corresponding ISO image.

In embodiments where the ISO image(s), the file(s) for the label(s) and the optional MD5 hash(es) are generated by a download server, these files may be transmitted to and temporarily stored by a data staging area. The data staging area may function as an overflow, a buffer and/or a queue for ISO images and corresponding files for labels, and may comprise memory, or a temporary storage medium, on which these files are temporarily stored before they can be written to archival media.

Once the ISO image(s) and the file(s) for the label(s) for a particular archive request have been generated, and the archiver (e.g., an ARU of the archiver, etc.) is prepared to archive the data, the ISO image(s) may be transferred to archival media. In embodiments where the archival media comprises optical discs, an optical disc may be inserted into an optical disc writer, which may then write an ISO image onto the optical disc. In some embodiments, a robot may insert the optical disc into the optical disc writer or otherwise associate an archival medium with an apparatus that will copy the ISO image, or the data contents of the ISO image, to the archival medium, or archive the data on the archival medium. When more than one ISO image has been generated to archive a requester's data, this process may be repeated until all of the ISO images, or the data corresponding to the ISO images, have been written to optical discs or otherwise copied onto archival media.

Once an ISO image or the data corresponding thereto has been archived on an archival medium, the archiver may compare the data on each archival medium to its corresponding ISO image (e.g., on memory of the data staging area, on memory associated with the download server, etc.) to confirm that the data that has been archived on the archival medium is the same data that was obtained through the requester's third party account.

In some embodiments, the ARU may also generate an MD5 hash from the data that has been archived on the archival medium, and then compare that MD5 hash to a previously generated MD5 hash (e.g., an MD5 hash generated by the download server, etc.). Such a comparison may ensure that the appropriate data (i.e., only data belonging to the requester) has been archived on the archival medium. Such a comparison may be used to verify the integrity of the data that has been archived.

If comparison of the data on the archival medium to the ISO image and/or comparison of the MD5 hashes demonstrates that the data on the archival medium differs from the requester's original data (e.g., due to corruption, due to the inclusion of data that does not belong to the requester, etc.), one or more of the processes of obtaining, processing and archiving the requester's data may be repeated. If the comparison(s) show that the correct data has been correctly archived, the archival medium or media may be prepared for shipment to the requester.

The archiver (e.g., by way of the ARU, etc.) may use a file for labeling each archival medium to print a label for that archival medium. Such a label may be printed directly onto the archival medium (e.g., when the archival medium comprises an optical disc, etc.), onto an adhesive label that may be applied to the archival medium or a housing for the archival medium or onto a package (e.g., a sleeve, a case, etc.) for the archival medium. In addition, using a file that has been generated for a shipping label, the archiver may print a shipping label.

Once the archival medium or media have been matched with a label (e.g., a shipping label, a label for a sleeve or a case, etc.) and placed into a package that carries the label, an optical code on the archival medium and/or the label may be scanned to confirm that the archival medium or media have been properly packaged for shipping to an address that has been identified by the requester or for cataloging in a secure storage facility maintained by the archiver. All of the files that were generated as part of the archival process may then be placed in a folder that has been designated to receive files that correspond to archival orders that have been fulfilled, from which these files may be deleted from the archiver's systems (e.g., the data staging area, the ARU, etc.).

In some embodiments, the archival process is completely automated.

The archiver may provide the requester with status updates during the course of the archival process. Status updates may be provided in the form of e-mail messages, desktop alerts, text messages or in any other suitable format. Without limitation, the archiver may provide a requester with a status update when the data that is to be archived has been scanned and indexed, the data has been spanned and one or more ISO images for the data have been generated. As another example, the requester may receive a status update when the data has been archived. The requester may also receive a status update when the archival medium is (media are) being shipped to an address designated by the requester. The archiver may also provide the requester with a notification, or reminder, that a previously scheduled or periodic follow-up archival session will occur at a specific time in the near future (e.g., one day, two days, etc.).

Various embodiments of methods according to this disclosure include any or all of the processes disclosed above. Without limitation, an archiver may request that a data archival service, or place an order with the data archival service to, archive data stored by one or more third party data storage services. In placing the order, the archiver's account with each such service may be accessed, data may be selected from each third party data storage service, and the selected data may be downloaded by the data archival service. The data archival service may write the selected data to an archival medium. The data archival service may store the archival medium to which the selected data has been written or send it to the archiver, who may personally store the archival medium.

Other aspects, as well as features and advantages of various aspects, of the disclosed subject matter will become apparent to those of ordinary skill in the art through consideration of the ensuing description and the appended claims.

### BRIEF DESCRIPTION OF THE DRAWINGS

In the drawings:

FIG. 1 is a schematic diagram illustrating an embodiment of a system for archiving data in accordance with this disclosure; such a system may be operated by a data archival service, or an archiver;

FIG. 2 is an image of a web page, which may be referred to as a “start page,” that may enable an individual who wants to archive data, who may also be referred to as a “customer,” to access a system for archiving data, such as that depicted by FIG. 1;

FIGS. 3 and 4 are image of web pages, which may be referred to as “third party account access pages,” that may enable a customer to cause a system for archiving data to interact with a third party data storage service;

FIG. 5 is an image of a web page, which may be referred to as a “third party interface page,” that may enable a customer to select files (e.g., image files, etc.) stored by the third party data storage service that are to be archived by a system for archiving data;

FIG. 6 is an image of a web page, which may be referred to as an “archive naming page,” that may enable a customer to name the data that is to be archived by a system for archiving data;

FIG. 7 is an image of a web page, which may be referred to as a “plan selection page,” that enables a customer to select an archival subscription plan;

FIG. 8 is an image of a web page, which may be referred to as a “customer information page,” through which a customer may input personal information that corresponds to data to be archived, such as a party name and a physical address to which a system for archiving data is to send a tangible medium on which a system or archiving data records the data;

FIG. 9 is an image of a web page, which may be referred to as a “payment page,” through which a customer may input payment information for archival services that are to be provided to the customer by a system for archiving data;

FIG. 10 is an image of a web page, which may be referred to as an “account information page,” showing information associated with a customer's account (e.g., identity, physical address, payment information, the identities of third party data storage services the customer has permitted the system for archiving data to access, etc.), and through which the customer may update or edit information associated with that account.

FIG. 11 is an image of a web page, which may be referred to as an “order review page,” which may display order information to an archiver to enable the customer to review the information before submitting an order;

FIG. 12 is an image of a web page, which may be referred to as a “confirmation page,” which may provide a customer with information relating to his or her order (e.g., an order number; a link to a web page showing information relating to the order, such as details, pricing, shipment tracking information, etc.; etc.);

FIG. 13 is an image of a web page, which may be referred to as an “order status page,” which may provide a customer with information relating to each order (e.g., details on the data to be archived, the identity of each third party data storage service from which the data has been imported, status of the data archival, including the status of connection with the third party data storage service, download status, confirmation status, and shipment tracking information, etc.);

FIGS. 14 and 15 are images of web pages, which may be referred to as “archiver status pages,” which may provide an individual (an “operator”) associated with the archiver with information on the status of one or more orders by one or more customers to archive data stored by one or more third party data storage services;

FIG. 16 is an image of a web page, which may be referred to as a “shipping label creation page,” through which an operator associated with an archiver may input and/or confirm shipment information for a customer to whom an archival medium, on which data has been recorded and archived, is to be sent; and

FIG. 17 is an image of a web page, which may be referred to as a “shipment confirmation page,” that may provide an operator associated with an archiver with confirmation that an order for an archival medium with data archived therein has been shipped to a customer.

### DETAILED DESCRIPTION

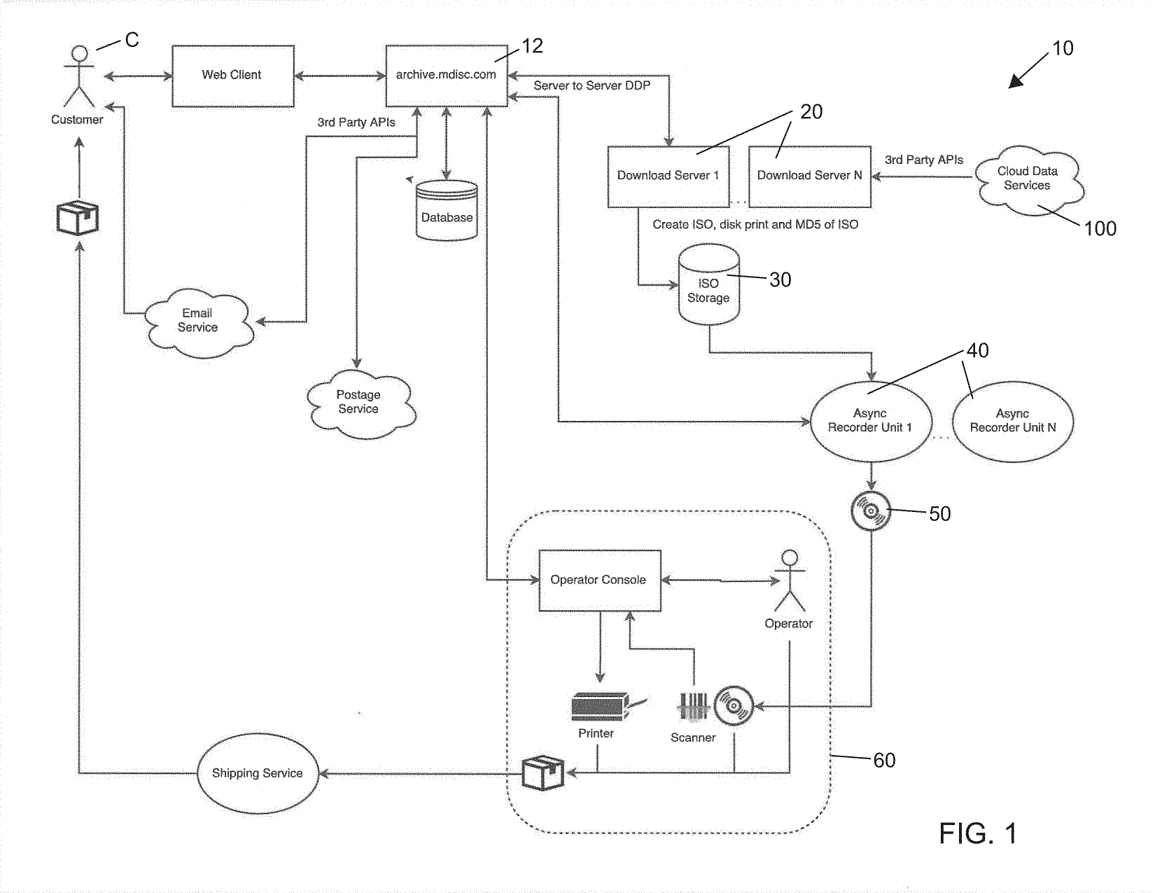

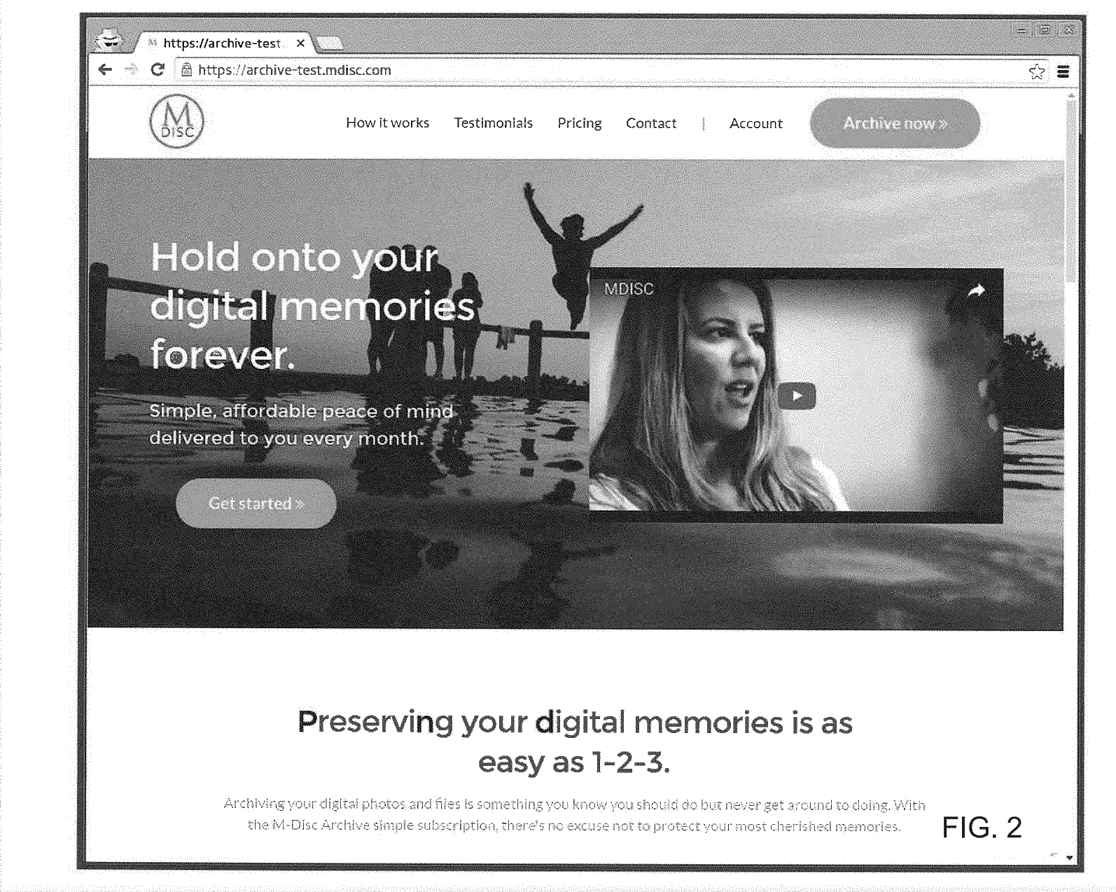

With reference to FIG. 1, as well as to FIGS. 2-17, as referenced, an embodiment of a system 10 for archiving data will be described. The system 10 may include one or more download servers 20, a data staging area 30 and one or more asynchronous recording units (ARU) 40. A download server 10 may receive a request from a party, or a requester (e.g., customer C) who wants to archive its, his or her data. Once the download server 20 receives a request, the download server 20 may establish communication with and obtain the customer C's data from a third party 100 (e.g., a server of a third party data storage service, i.e., the Cloud, etc.). That data may be transmitted, or sent, by the third party 100 to the data staging area 30, which includes memory where the data may be temporarily stored until the ARU 40 is able to copy the data onto an archival medium 50. The data on the archival medium 50 may be compared with the data temporarily stored by the data staging area 30 to confirm that only the customer C's data is stored, or archived, by the archival medium 50. The system 10 may also include a transmittal component 60 and/or a secure storage component (not shown). The transmittal component 60 may receive the archival medium 50 or media 50 from the ARU 40 and send it to an address designated by the customer C. A secure storage component may comprise a secure location where the archival medium may be stored until the user requests it, for example, by way of a request that the archival medium 50 or media 50 be sent to an address designated by the customer 50.

In various embodiments of a method according to this disclosure, the customer C accesses the system 10 (e.g., the archiver's web site, etc.) through a user interface 12 (e.g., an internet browser, etc.), such as that depicted by FIG. 2. Through the user interface, the customer C may initiate a call to action (e.g., by selecting a particular action, such as an “Archive Now” icon, etc.).

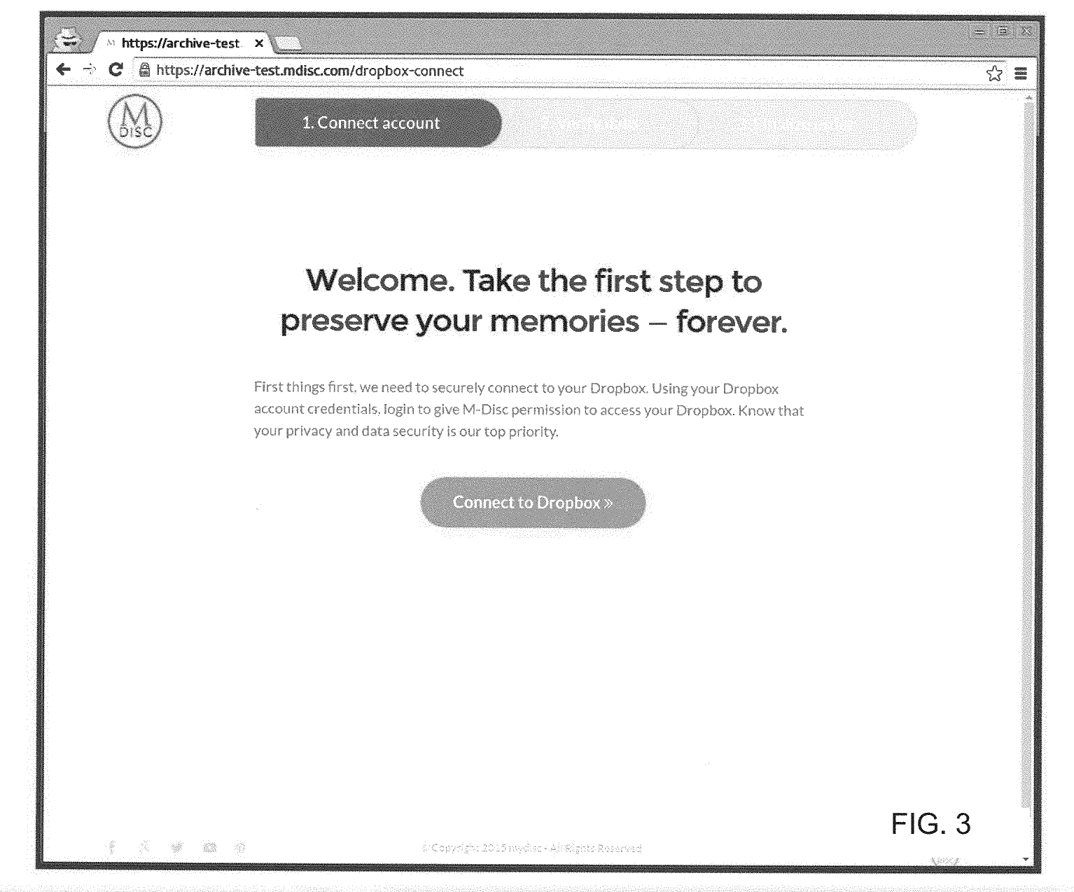

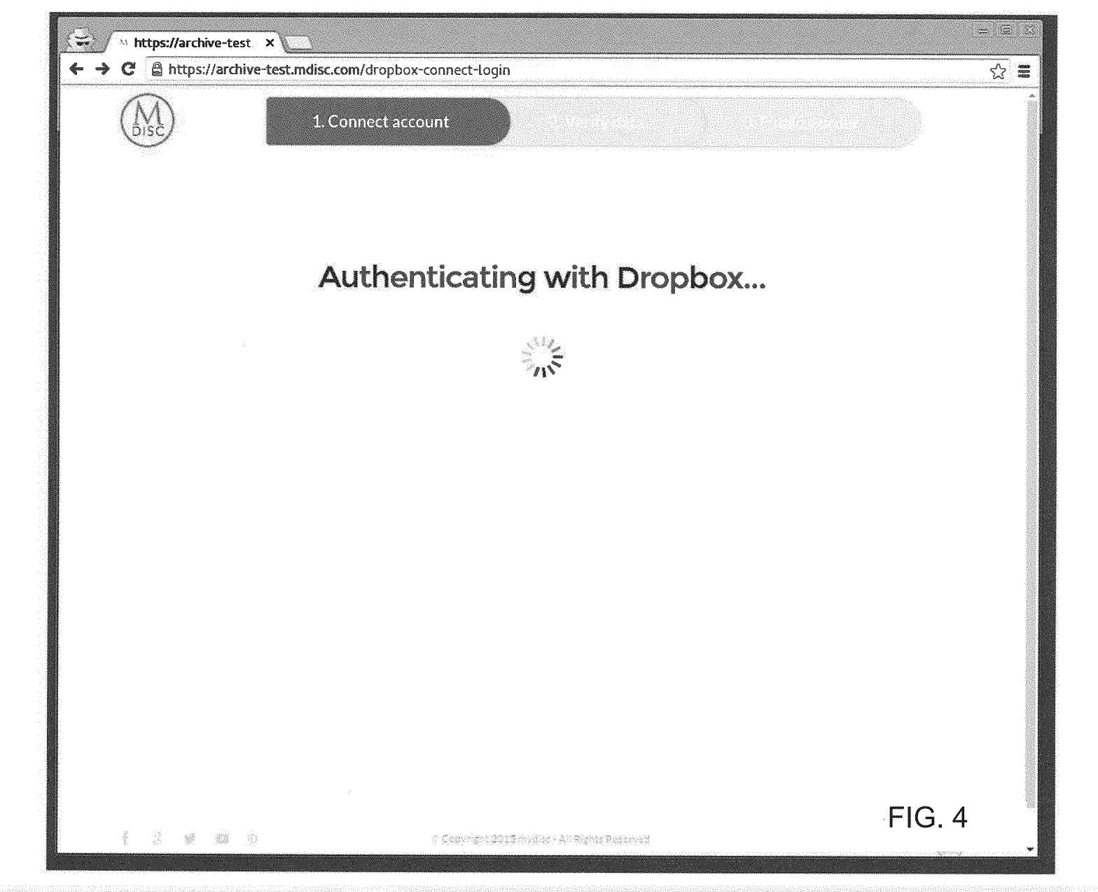

As illustrated by FIG. 3, once the customer C initiates the call to action, the user interface 12 to the download server enables the customer C to identify a website or other internet-accessible location from which the archiver may access the data the requester would like to archive, and links to that location. Once the archiver has access to the requester's data, the archiver (e.g., by way of the download server, etc.) may access the data stored by the requester in connection with the requester's third party account, as illustrated by FIG. 4.

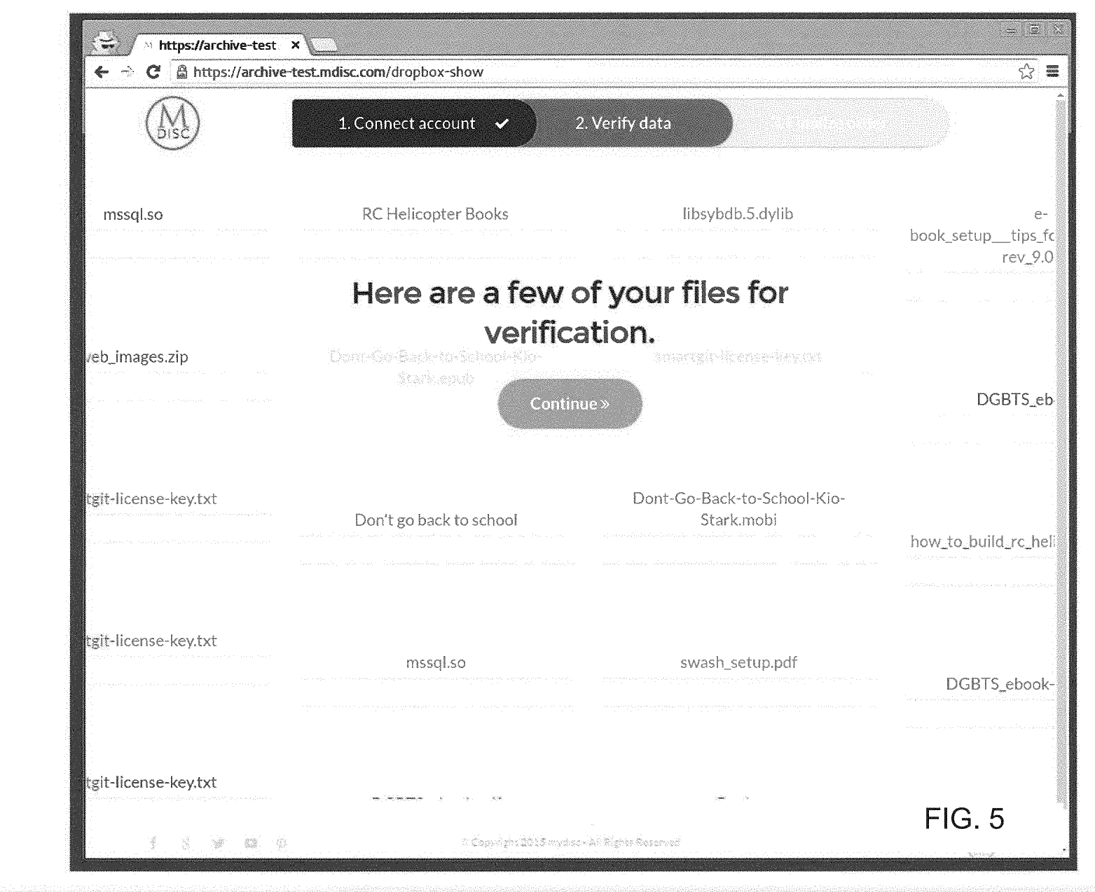

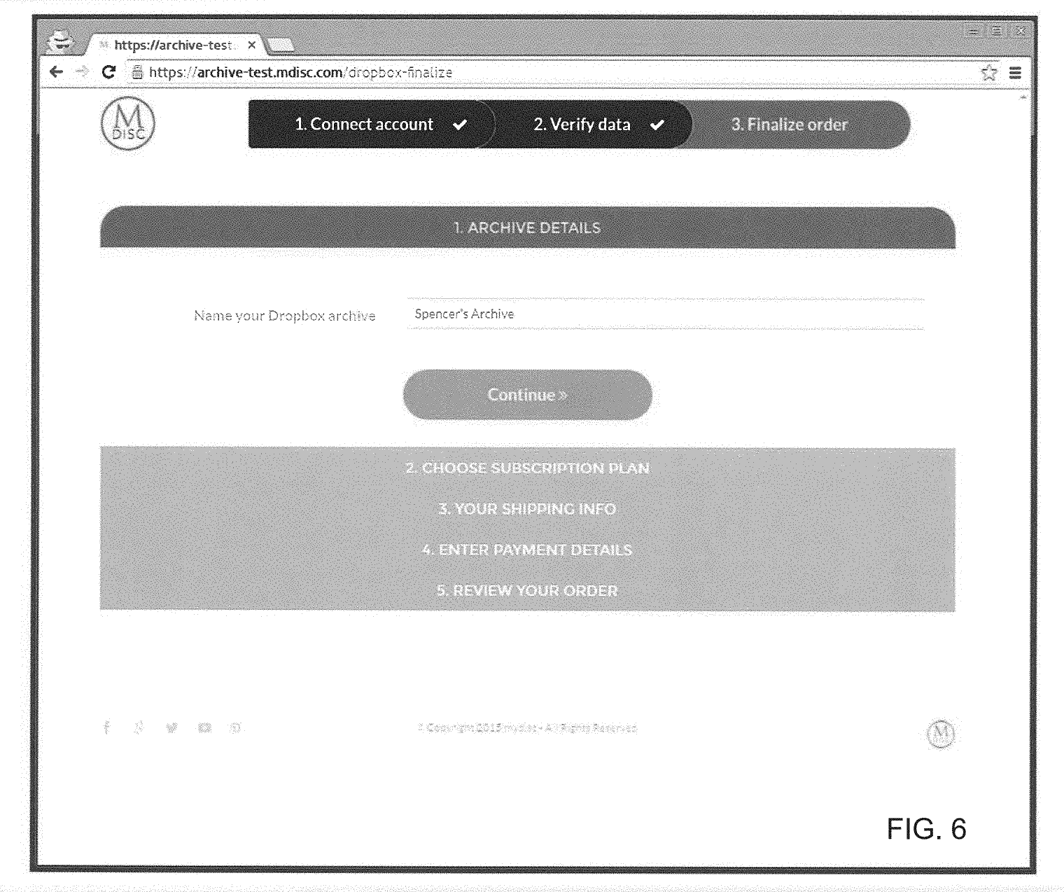

Upon accessing the customer C's account, the archiver may index all of the data files that are stored in connection with that account, and provide the customer C, through the user interface 12, enable the customer C to select from the indexed files, as shown in FIG. 5. Once the customer C or the archiver has identified which of the customer C's files, or data, are to be archived, the customer C may provide the archival session with an identifier (i.e., name it) through the user interface 12, as shown in FIG. 6. The archiver may then download (e.g., by way of the download server, etc.) each file that is to be archived.

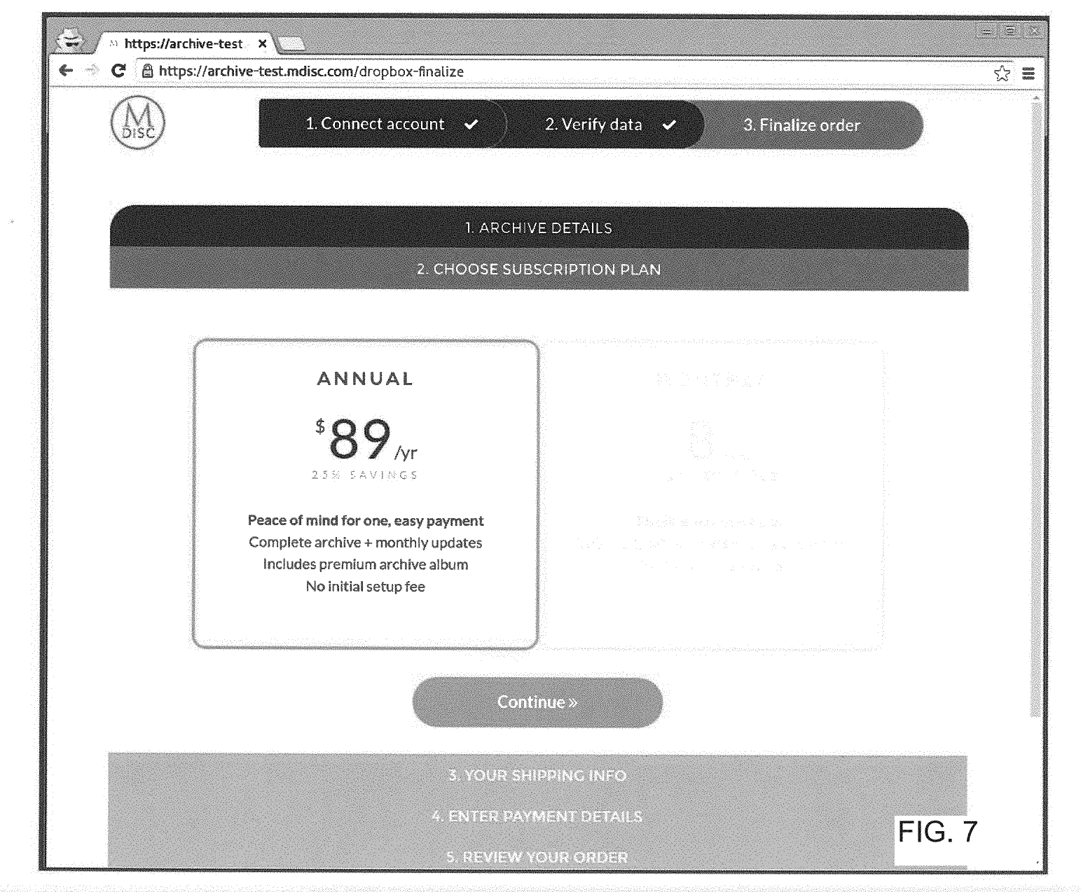

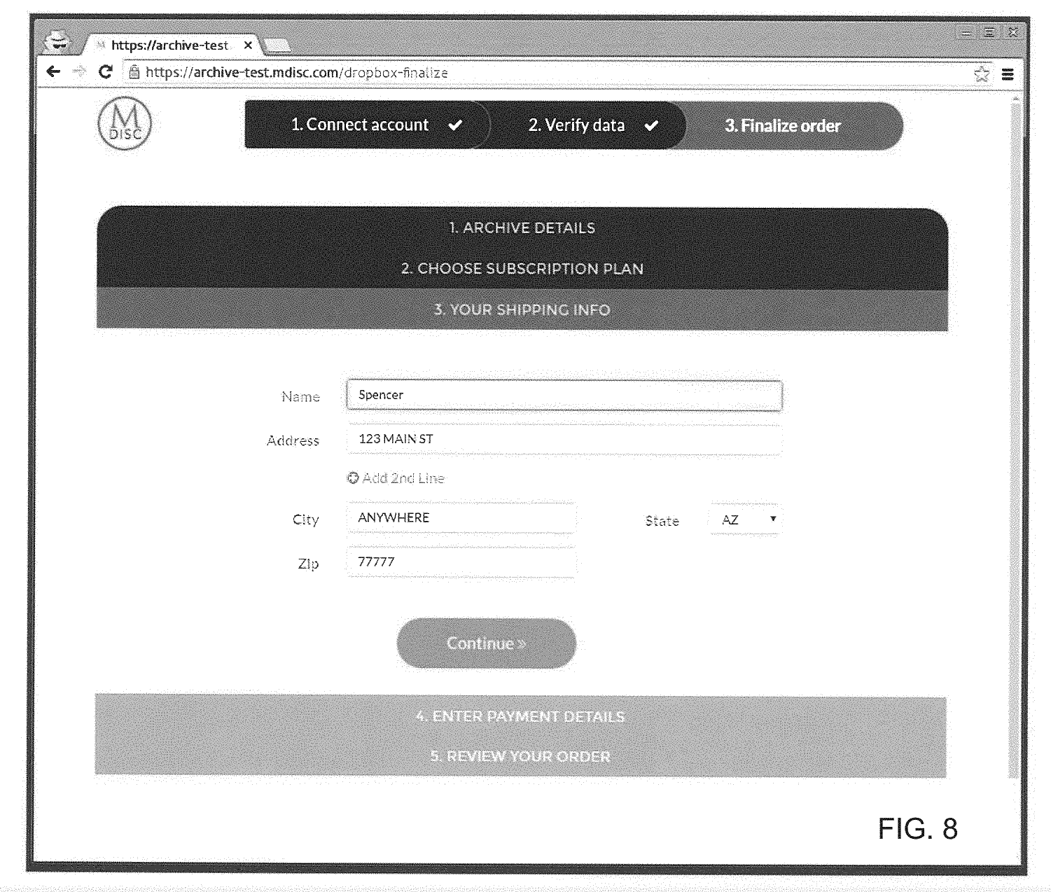

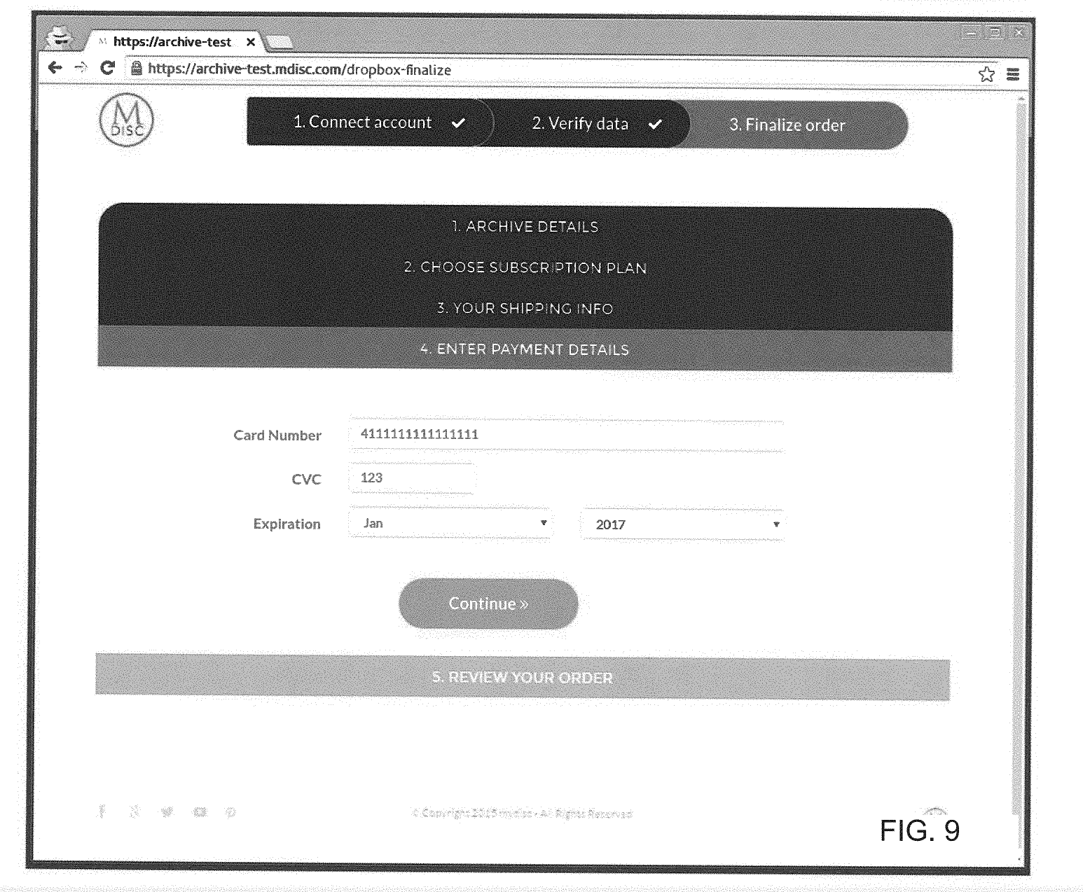

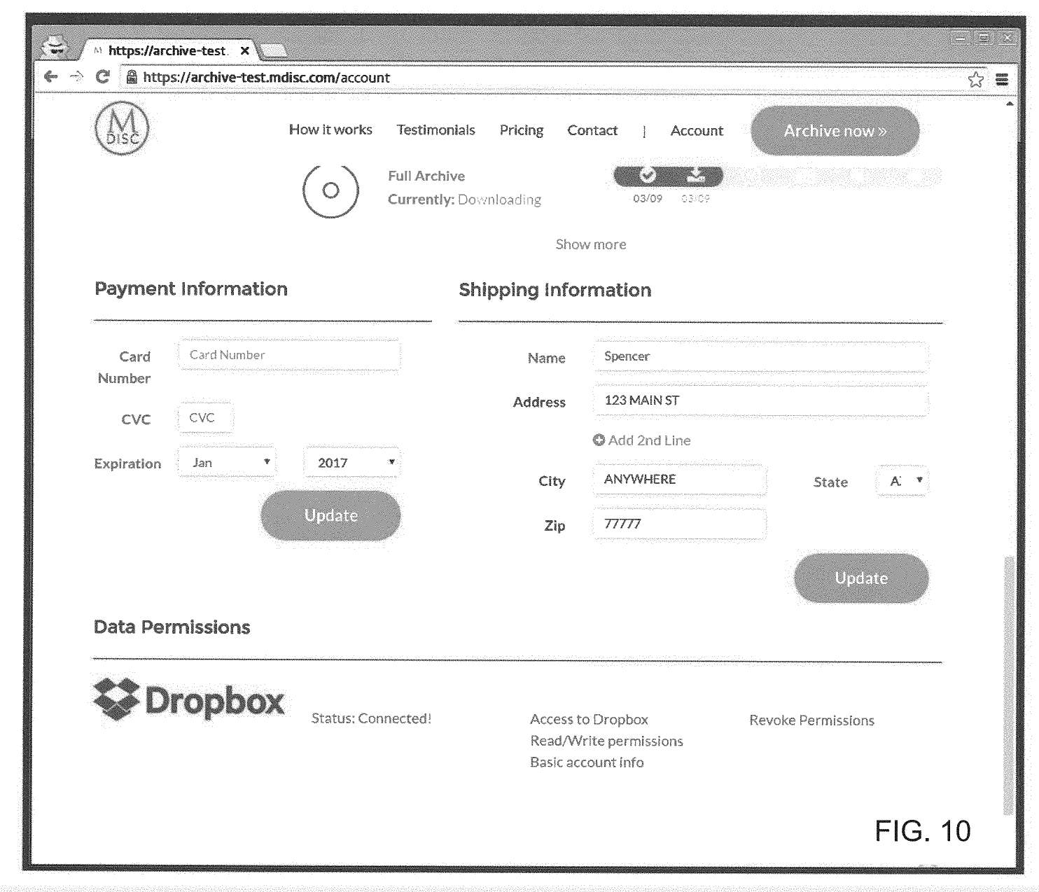

In embodiments where the customer C has not previously used the archiver to archive data, the customer C may, through the user interface 12, select the manner in which he or she would like to archive data, as illustrated by FIG. 7. Without limitation, the customer C may subscribe to the archiver's services on a monthly basis, on an annual basis, etc. Once the customer C has selected a subscription/payment plan, he or she may input his or her shipping information through the user interface 12, as shown in FIG. 8, and his or her payment information, as shown in FIG. 9. The customer C may have the opportunity to view, also through the user interface 12, and/or update his or her shipping information and payment information, as depicted by FIG. 10.

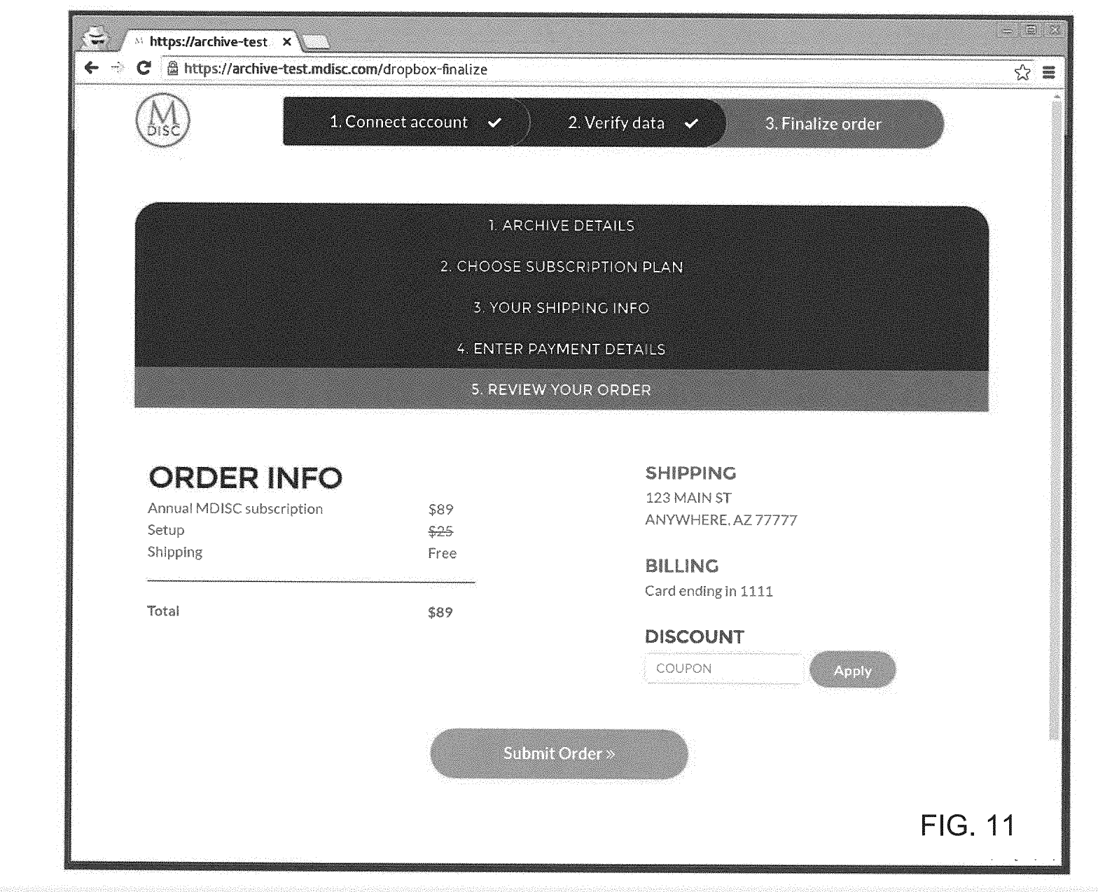

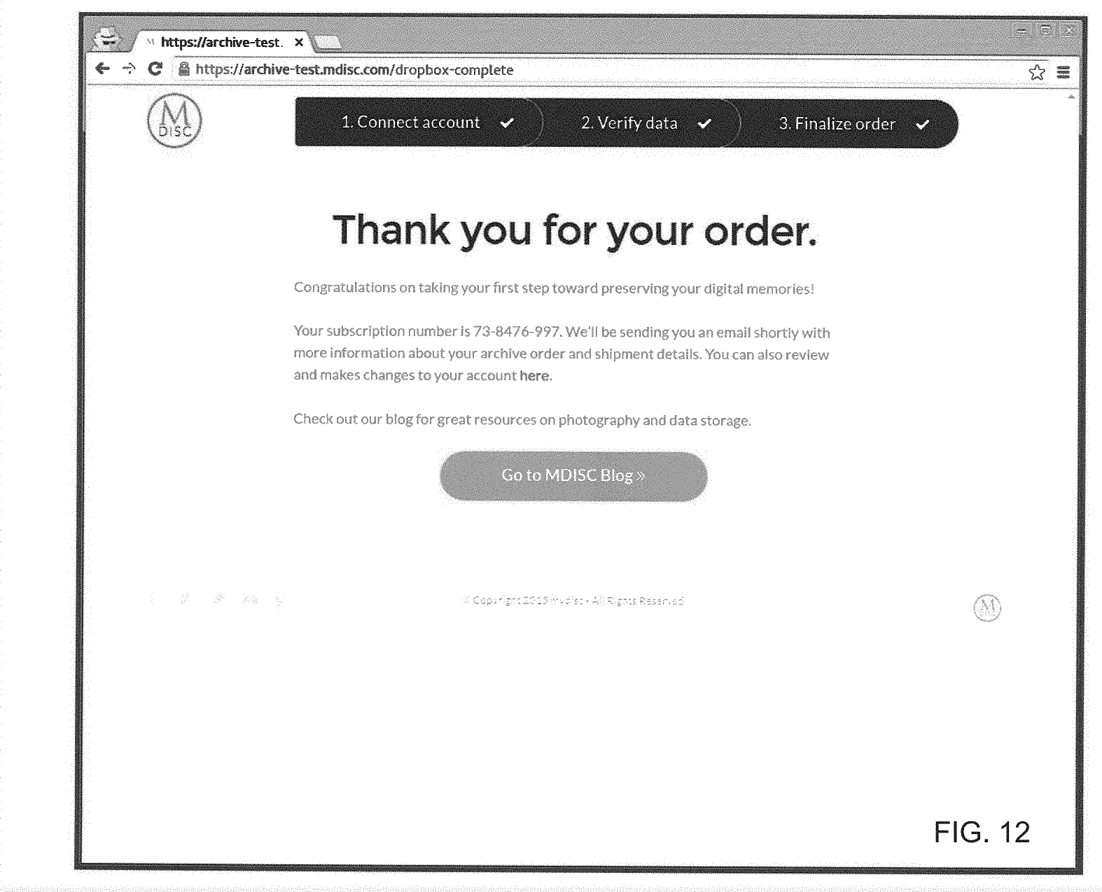

As illustrated by FIG. 11, the customer C may be given the opportunity to review his or her order for data archival. The system 10 may provide the customer C with confirmation that the order has been received, as shown by FIG. 12.

Once an order is received, the system 10 may access the data that is to be archived from a third party 100, download the data (e.g., to a download server 20), prepare the data to be written to an archival medium (e.g., at the data staging area 30), and write the data to the archival medium 50 (e.g., at an ARU 40).

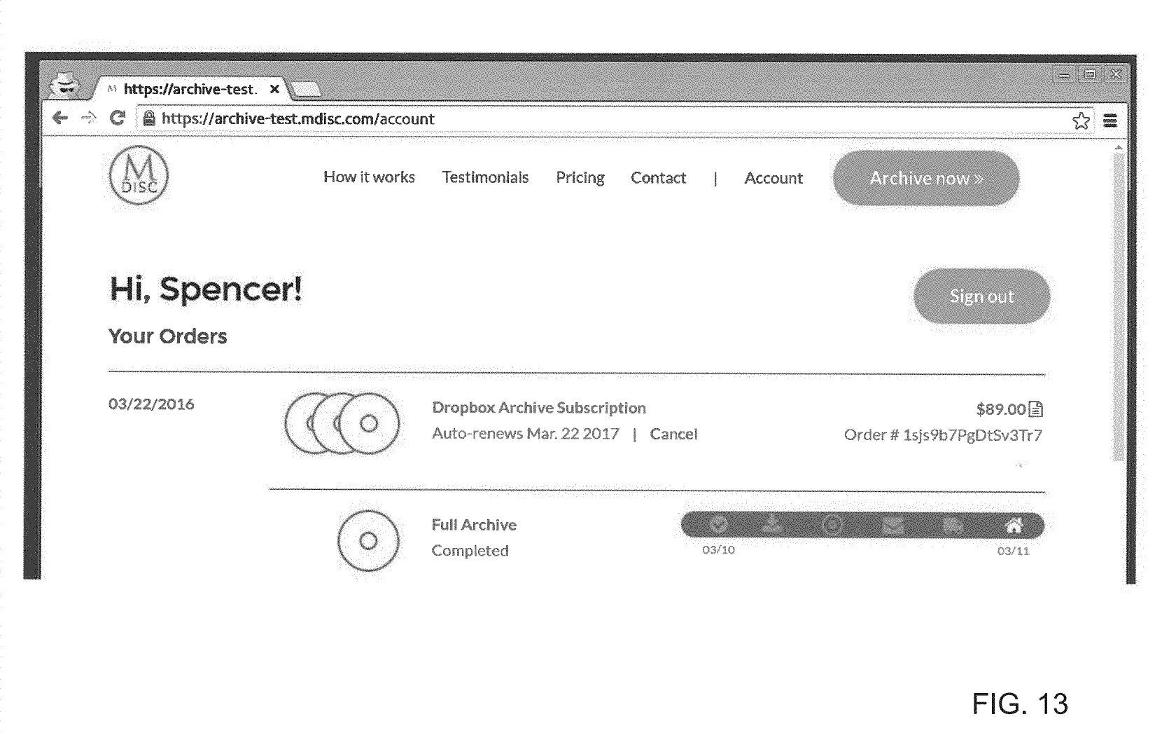

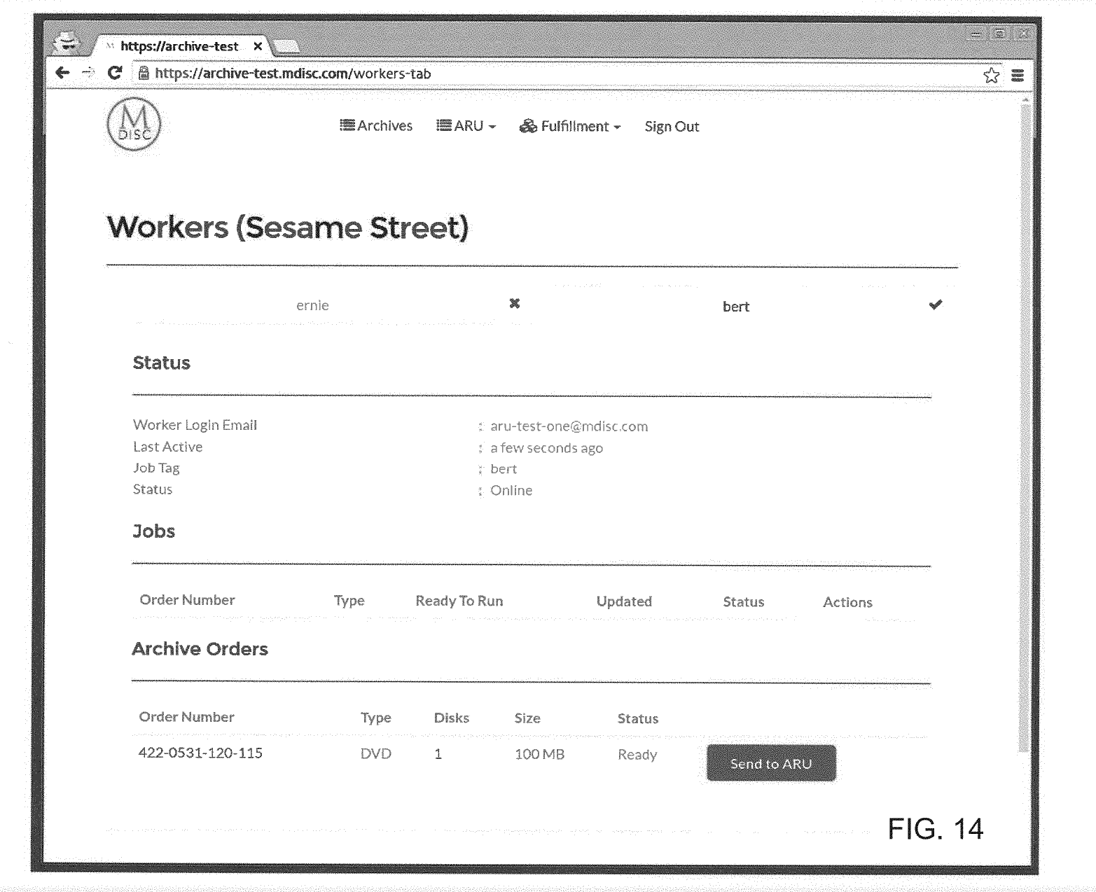

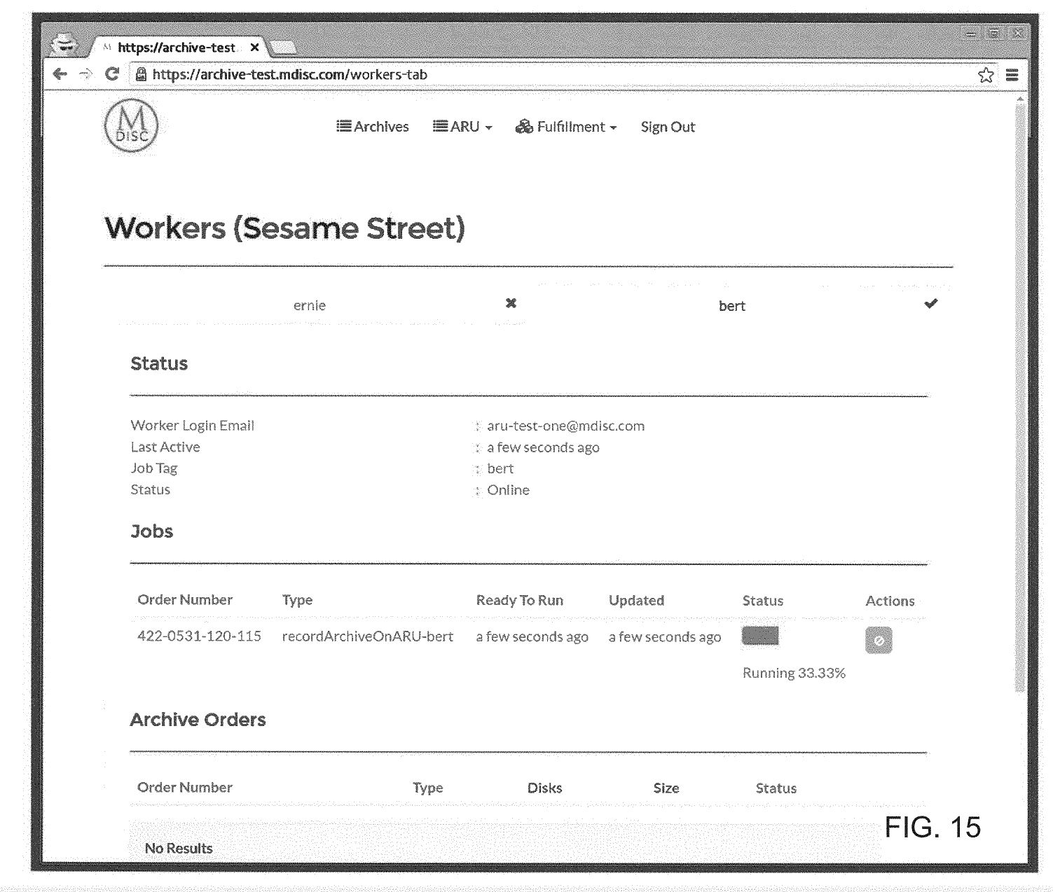

The customer C may access further information about the status of his or her order through the user interface 12, as depicted by FIG. 13. Such information may include the date the order was placed, the option to cancel the order or a subscription, the price paid for the order or the subscription, and the status of the order. Order status information may, more specifically, include information about the status of downloading data in connection with the order, the status of writing the data to an archival medium, shipping status, and shipment tracking information. The system 10 may also enable the archiver, or an operator associated with (e.g., employed by, etc.) the archiver to see information on the status of one or more archival orders, as illustrated by FIGS. 14 and 15.

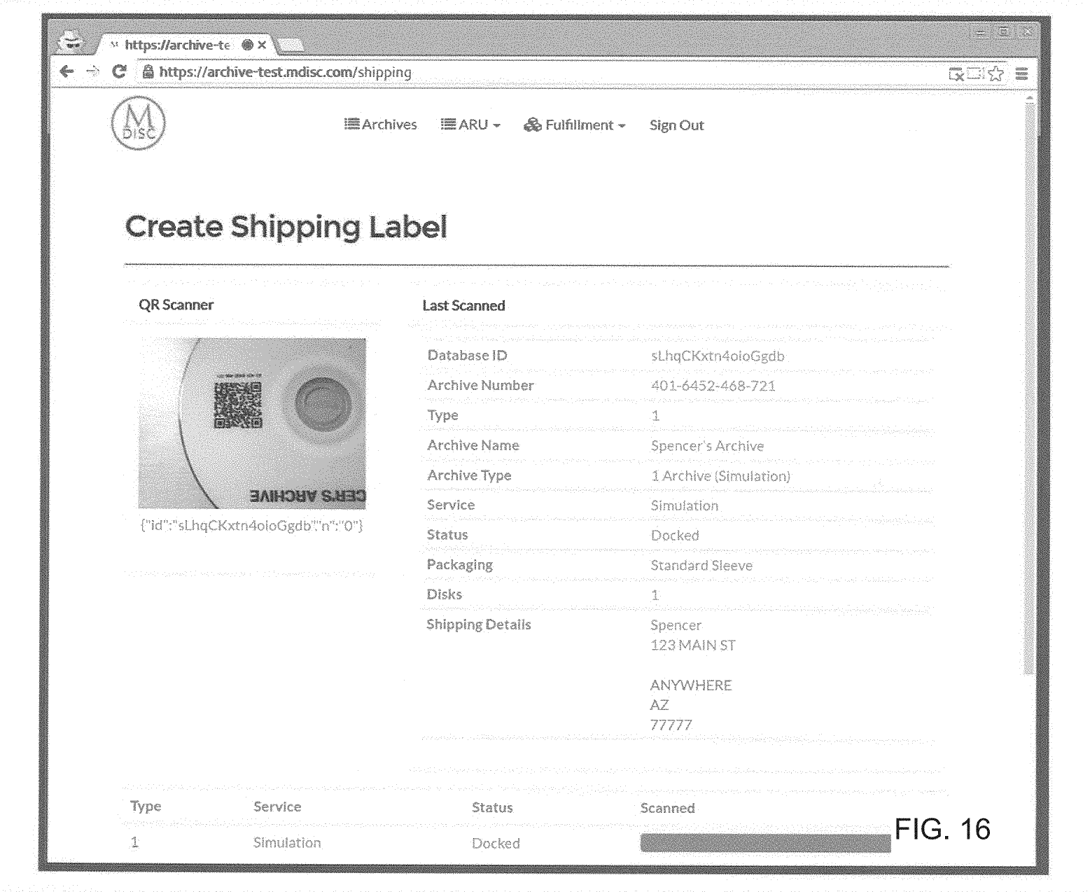

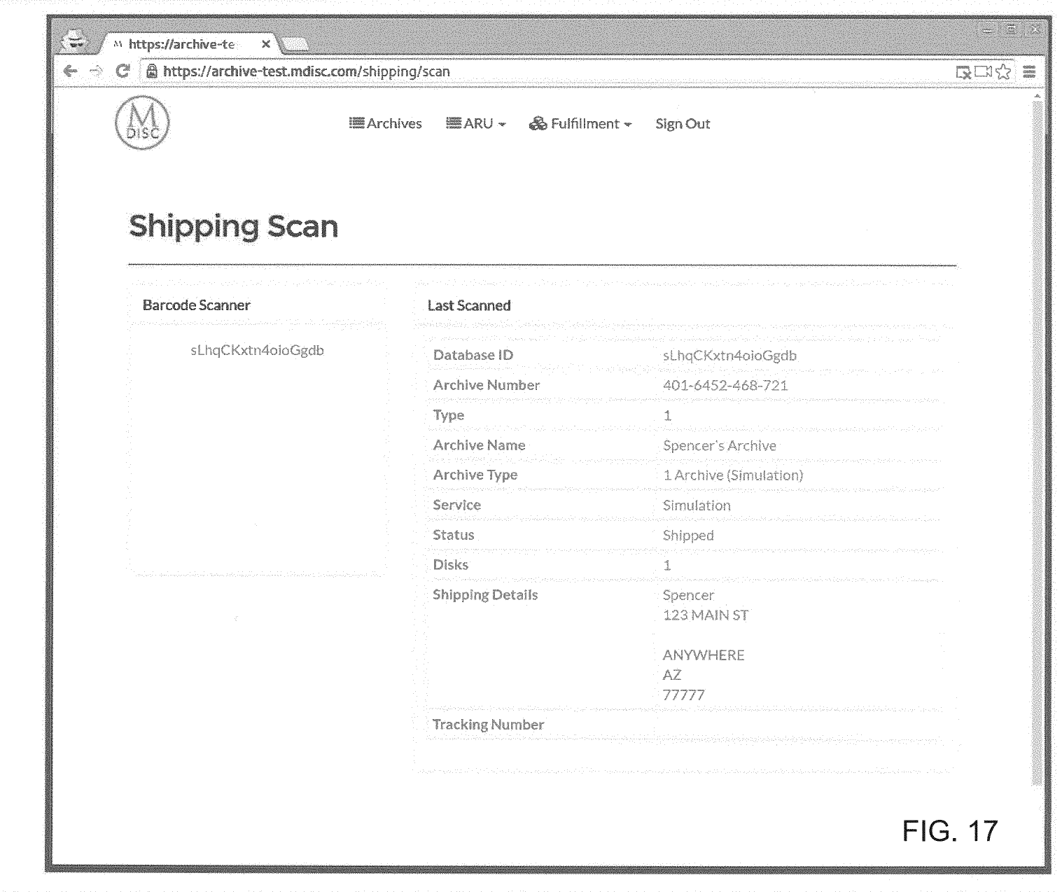

Once data that is to be archived is written to an archival medium, it may be prepare for shipment to the customer C. FIG. 16 shows an embodiment of a “shipping label creation page,” through which an operator associated with an archiver may input and/or confirm shipment information for a customer to whom an archival medium, on which data has been recorded and archived, is to be sent. The information input into shipping label creation page may be used by the transmittal component 60 of the system to package, label, and ship the archival medium 50 to the customer C. The system 10 may provide the archiver, or an operator associated with the archiver, with confirmation that an order for an archival medium 50 with data written thereto has been shipped to a customer C, as depicted by FIG. 17.

Although the foregoing disclosure sets forth many specifics, these should not be construed as limiting the scope of any of the claims, but merely as providing illustrations of some embodiments and variations of elements and/or features of the disclosed subject matter. Other embodiments of the disclosed subject matter may be devised which do not depart from the spirit or scope of any of the claims. Features from different embodiments may be employed in combination. Accordingly, the scope of each claim is limited only by its plain language and the legal equivalents thereto.

What is claimed:

1. A data archival system, comprising:
a download server capable of:
receiving an archive request from a requester;
receiving authorization to access the requester's data from a third party system;
interacting with the third party system to retrieve the requester's data;
organizing the data in a format suitable for archival upon at least one archival medium; and
assembling at least one ISO image of the requester's data to be copied to the at least one archival medium;
a data staging area for receiving the at least one ISO image; and
an asynchronous recording unit capable of:
copying data of the at least one ISO image to the at least one archival medium;
comparing the data stored by the at least one archival medium to the at least one ISO image; and
preparing the at least one archival medium for shipment to an address designated by the requester.

2. The data archival system of claim 1, wherein:
the download server is further capable of:
generating a file for at least one label for the at least one archival medium; and
the asynchronous recording unit is further capable of:
printing the at least one label.

3. The data archival system of claim 2, wherein the at least one label comprises a label to be affixed to the at least one archival medium.

4. The data archival system of claim 2, wherein the at least one label comprises a shipping label to be affixed to a package for the at least one archival medium.

5. The data archival system of claim 2, wherein:
the asynchronous recording unit is further capable of:
scanning the at least one label.

6. The data archival system of claim 5, wherein:
the asynchronous recording unit is further capable of:
confirming that the at least one label corresponds to the data stored by the at least one archival medium.

7. The data archival system of claim 6, wherein:
the asynchronous recording unit is further capable of:
confirming that a labeled package for the at least one archival medium corresponds to the at least one archival medium.

8. The data archival system of claim 6, wherein:
the asynchronous recording unit is further capable of:
removing the at least one ISO image from the data staging area.

9. The data archival system of claim 1, wherein:
the download server is further capable of:
generating an MD5 hash of the requester's data; and
the asynchronous recording unit is further capable of:
generating an MD5 hash of the data stored by the at least one archival medium; and
comparing the MD5 hash of the data stored by the at least one archival medium to the MD5 hash of the requester's data.

10. The data archival system of claim 9, wherein the asynchronous recording unit is capable of comparing the MD5 hash of the data stored by the at least one archival medium to the MD5 hash of the requester's data to confirm that the data stored by the at least one archival medium corresponds to the requester's data retrieved by the download server.

11. The data archival system of claim 9, wherein the asynchronous recording unit is capable of comparing the MD5 hash of the data stored by the at least one archival medium to the MD5 hash of the requester's data to verify an integrity of the data stored by the at least one archival medium.

12. The data archival system of claim 1, wherein the asynchronous recording unit is capable of comparing the data stored by the at least one archival medium to the at least one ISO image to confirm that the data stored by the at least one archival medium corresponds to the requester's data retrieved by the download server.

13. The data archival system of claim 1, wherein:
the download server is further capable of:
indexing the requester's data to enable selective archival of the requester's data.

14. The data archival system of claim 13, wherein:
the download server is further capable of:
indexing the requester's data to prevent duplicative archival of at least some of the requester's data.

15. A method for archiving data, comprising:
receiving a request from a requester to archive the requester's data stored by a third party system;
receiving authorization from the requester to access the third party system;
accessing the requester's data from the third party system;
indexing the requester's data;
generating at least one ISO image from at least some of the requester's data;
copying data of the at least one ISO image to at least one archival medium;
confirming that the data stored by the at least one archival medium corresponds to the requester's data accessed from the third party system; and
sending the at least one archival medium to an address designated by the requester.

16. The method of claim 15, wherein indexing the data includes identifying files of the requester's data that are to be archived.

17. The method of claim 16, wherein indexing the data includes identifying files of the requester's data that have been previously archived.

18. The method of claim 15, further comprising:
repeating the accessing, the indexing, the generating, the copying, the confirming and the sending at least once.

19. The method of claim 18, wherein repeating comprises periodically repeating the accessing, the indexing, the generating, the copying, the confirming and the sending in archiving new data of the requester stored by the third party system.

20. The method of claim 19, wherein archiving new data of the requester comprises archiving the new data without re-archiving the requester's data that was archived during a previous session of accessing, indexing, generating, copying, confirming and sending.
